(19) United States
(12) Patent Application Publication
(10) Pub. No.: US 2010/0244629 A1
(43) Pub. Date: Sep. 30, 2010

(54) Piezoelectric Generator

(75) Inventors: Susumu Nagashima, Tokyo (JP); Ryotaro Matsumura, Tokyo (JP)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Ceratec Corporation, Tokyo (JP)

(21) Appl. No.: 12/748,500

(22) Filed: Mar. 29, 2010

(30) Foreign Application Priority Data
Mar. 31, 2009 (JP) 2009-103424

(51) Int. Cl. H02N 2/18

(52) U.S. Cl. 310/339

(57) ABSTRACT

The piezoelectric generator is characterized by providing a spacer member in the vicinity of a fixed end of an elastic plate mounted on a base plate by means of affixing both ends in such a way as to prevent the elastic plate not to be deformed unnecessarily when a load is applied to the elastic plate from above, so that a piezoelectric ceramic plate glued onto the elastic plate generates electric power by the elastic plate's deformation.

### BACKGROUND

1. Technical Field

The present invention relates to a piezoelectric generator for converting mechanical loads and vibrations to the strains of a piezoelectric material and take out electrical energy.

2. Description of Related Art

There have been developments of various techniques lately for using electrical energy generated by the strains of piezoelectric materials caused by external forces and vibrations. It is a common practice to use a piezoelectric generator in order to obtain electrical energy from a piezoelectric material. A piezoelectric generator is essentially a unit that causes strains in a piezoelectric device by means of impacting it with an impacting member formed as a metallic sphere or a ceramic sphere, or by fixing one end of a piezoelectric element and pressing or vibrating the other end of it. The electric energy obtained by a piezoelectric generator is used for illuminating a light emitting diode directly, or stored in a capacitor or a secondary battery to be taken out and used for driving a signal processing device, etc., as needed.

The key requirements in the practical phase of installing such a piezoelectric generator outdoors and use the pressure change applied to the generator for power generation include:
it has a high power generating efficiency by means of fully absorbing impact forces and pressures mechanically applied to it;
it is constructed rigidly to resist mechanical damages;
it has a structure well-considered for water resisting;
it has a simple structure to allow easy manufacture; etc.

Various generator s have been proposed so far. For example, Publication of Unexamined Japanese Patent Application No. 2005-57982 discloses a pendulum-type generator equipped with a piezoelectric bimorph of a cantilever beam structure, so that it receives vibrations and generates power as a person carrying it walks.

Publication of Unexamined Japanese Patent Application No. H05-39661 discloses a building floor material which is capable of generating power using a piezoelectric ceramic material. The particular floor material is incorporated with a plurality of cylindrical piezoelectric elements between block-like plates to be laid out as the floor so that the piezoelectric elements receive pressures in the axial direction.

Publication of Unexamined Japanese Patent Application No. H11-353913 discloses a power generating device to be used as a lighting device for stairs by having pressure-sensitive steel devices on the steps or on the floor in the vicinity of the entrance or steps of a stair.

However, these power generating devices have either piezoelectric ceramics pinched between floor plates or installed on the steps of stairs, so that power generating efficiency is not too good, as the strains developed in the piezoelectric ceramics are limited because of limited elastic modulus of the piezoelectric ceramics. In particular, in case a piezoelectric bimorph is used for power generation, securing of a certain gap is indispensable to allow a displacement to occur under a load, but no gap is secured.

Publication of Unexamined Japanese Patent Application No. 2006-32935 discloses a power generating system in which electric power is generated by means of pressure changes as a vehicle or a pedestrian passes over a road plate in which a plurality of piezoelectric elements are assemble three-dimensionally in order to improve the power generating performance.

Publication of Unexamined Japanese Patent Application No. 2008-190267 discloses a light-emitting system in which a power generating block installed on the road surface causes light emitting diodes to light on and off by means of a piezoelectric element built into the block.

These systems are designed in such a way that a constituting member will serve as a stopper to limit the deformation of the piezoelectric bimorph under an external force to be limited within a certain limit as a means of protection against damage.

However, the former power generating system is designed in such a way as to have one end of the piezoelectric power generating bimorph affixed on the sidewall of a case that forms the power generating block and to receive the load on the other end of the cantilever beam type bimorph located in the middle of it. When such a device is installed on the sidewall, it becomes a three dimensional arrangement and can be a cause of an increase of assembling man-hour. In particular, a plurality of the bimorph elements are built into such a device in order to secure a sufficient amount of power generation in those cases, so that the problem can be a more realistic one.

In the latter power generating system, the load bearing area is small so that the generated strain is limited and may cause a problem in the power generating efficiency, Such a power generating system can be considered a kind of an elastic system, and that the size of the energy E to be stored in the elastic system can be defined as:

E=1/2Kd² (1)

where K is the spring constant and d is the displacement.

As can be seen clearly in the formula (1), so long as it is assumed that a constant displacement d can be secured using an external load, it is possible to generate a larger stored energy E by adopting a larger spring constant K within a reasonable design range to establish an advantageous generator.

In a piezoelectric generation using the pressure change during the passage of a pedestrian or vehicle, a piezoelectric bimorph element or a piezoelectric unimorph element with a smaller compliance is used primarily so that a sufficient strain can be generated with a relatively small force.

The difference between the piezoelectric bimorph element and the piezoelectric unimorph element is a difference whether piezoelectric elements are attached on one side of the elastic material or on both sides, both elements can use selectively according to its purpose. Incidentally, the word “piezoelectric element” when it is used in this specification means both the piezoelectric bimorph element and the piezoelectric unimorph element.

Although it is advantageous for power generation that the piezoelectric bimorph has a small compliance, a generator with a larger stored energy E and better efficiency can be achieved by adjusting the compliance as large as possible if it is possible to secure a larger displacement d applying a larger external force.

While the cantilever beam type theoretically has a smallest compliance so that it reacts more easily for a weak force among various supporting methods for the piezoelectric bimorph element, the adjustment for increasing the compliance can be accomplished by increasing the thickness of the piezoelectric bimorph element or shortening the effective length of the piezoelectric bimorph element. However, it was confirmed that such an approach can lead to the breakage of the piezoelectric bimorph element and result in a poor durability as it increase the strain caused in the affixing area.

Moreover, although the compliance can be increased by using a double-side-supported beam type piezoelectric bimorph element, i.e., by supporting both ends of the piezoelectric bimorph element from beneath to receive a load applied from above a supporting condition, it was learned that instability of the affixing becomes inevitable, thus being unable to achieve a stable power generating performance in such a case.

It was further revealed that although the compliance can be maximized by supporting a piezoelectric bimorph element at both ends, it was learned that such an arrangement is undesirable as it develops positive and negative bending moments on the piezoelectric bimorph element when a load is applied, thus causing cancellation of electric charges, resulting in a reduced power generation.

The inventors of the present invention succeeded in the invention when they found after intensive studies that only a constant bending moment develops always on a piezoelectric ceramics plate and no cancellation of charges occurs thus increasing the amount of power generation, by affixing a rectangular elastic plate bent in an arc shape at both ends to a base plate and gluing a piezoelectric ceramics plate to said elastic plate.

### SUMMARY

The objective of the present invention is to provide a piezoelectric generator that is water-resistant, robust, and has a high power generating capability, being capable of sensing vibrations and pressures with a high sensitivity in order to generate electric power.

In order to achieve the above-mentioned objective, the present invention is a piezoelectric generator for causing a strain on a piezoelectric element by an external force or vibration characterized in comprising a flat base plate, an elastic plate, which is bent in an arc shape and is attached to said base plate at both ends thereof so that a space is created to allow the elastic plate to deform between it and the particular base plate, and a spacer member having a fulcrum, which is located between one of the fixed ends of the particular elastic plate and the peak point of said arc-like curve for supporting said elastic plate in the vicinity of said one end of thereof, the spacer member being provided to form a space between its side opposite to the base plate and said elastic plate for allowing the elastic plate to deform, wherein said piezoelectric element is glued to at least one of the front and back surfaces of said elastic plate.

According to the present invention, the elastic plate deforms in a big way from a position convexed upward to a position convexed downward, causing a compression strain in the piezoeletric element over its entirety as this deformation progresses, thus generating electric charges and hence causing an effective power generating action. Next, as the load is removed, the elastic energy stored in the elastic system with the piezoelectric element and the elastic plate is released, while the piezoelectric element is agitated again by impact vibrations caused by the releasing process of the elastic energy, and another power generation action occurs at this point as well. In other words, for example, if a piezoelectric element is glued onto the surface of the elastic plate which is affixed at both ends to form an upward convex shape, and the elastic plate is deformed to create a downward convex shape, the entire piezoelectric element will be compressed, rather than both ends having tensile deformations and the center portion having a compressive deformation, so that only a constant bending moment occurs without causing any electric charge cancellation, thus increasing the rate of power generation.

Said elastic plate is shaped substantially rectangular and is bent like an arc as mentioned before, with its peak point located a little off the center in the lengthwise direction thus having a flat area with a reduced curvature away from the peak, so that if such a flat area is used as a location for gluing the piezoelectric element, it not only makes the gluing process easier but also causes less flexing thus minimizing the peeling of the piezoelectric element. Moreover, such a constitution provides a space for allowing the elastic plate to deform relative to the base plate so that the piezoelectric element can be located in the area where it can be easily deformed to store the elastic energy as it is subjected to a load from above.

Also, in case of the elastic plate bent in an arc shape, the spring constant when a pressure is applied to the peak point P is several tens of times larger than the spring constant of a straight beam affixed on both ends, so that the elastic energy that can be stored as expressed in the aforementioned formula (1) becomes larger, thus causing a larger distortion of the piezoelectric ceramic plate caused by said vibrations, and hence a amount of power generation become larger as well.

Furthermore, taking advantage of the fact that the peak point moves toward the fulcrum point of the spacer member as the load increases, it is possible to adjust the spacer member to be located exactly beneath the loading point when the load exceeds a certain load, which functions as a protection mechanism for the piezoelectric element by limiting the elastic deformation not to proceed further once such a state is reached.

The piezoelectric element is made as a water-resistant, mechanically robust, non-destructible and simple component by constituting it of a flat piezoelectric ceramic plate and coating said piezoelectric ceramic plate with a water-resistant material. Using an organic material such as rubber or elastomer as a water resistant material makes it easier to fabricate it.

### BRIEF DESCRIPTION OF THE DRAWINGS

FIG. 1 is a perspective view of an embodiment of the present invention.

FIG. 2 is a cross-sectional view along the direction of the length of FIG. 1.

FIG. 3 is an explanatory diagram concerning the operating principle of the same embodiment.

FIG. 4 is an explanatory diagram showing a deformation status of the elastic plate of the same embodiment.

### DESCRIPTION OF THE PREFERRED EMBODIMENTS

The embodiments of the present invention will be described below with reference to the accompanying drawings.

The piezoelectric generator 1 of the present embodiment comprises, as shown in FIG. 1, a base plate 2, an elastic plate 3, a spacer member 4, and a piezoelectric element 5 glued on to the top surface of the elastic plate 3. In the accompanying drawings, “D” represents lead wires connected to the piezoelectric element 5 for collecting electric current.

The base plate 2 is a substantially flat piece made of metal having a rectangular shape in a two dimensional view. Its material is preferable to have corrosion resistance similar to that of SUS (stainless steel), etc.

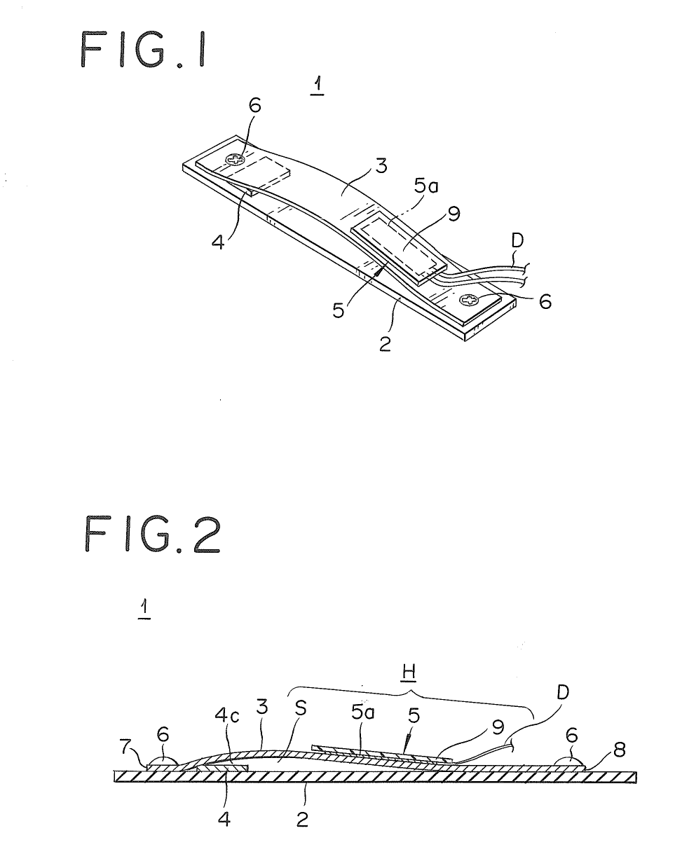

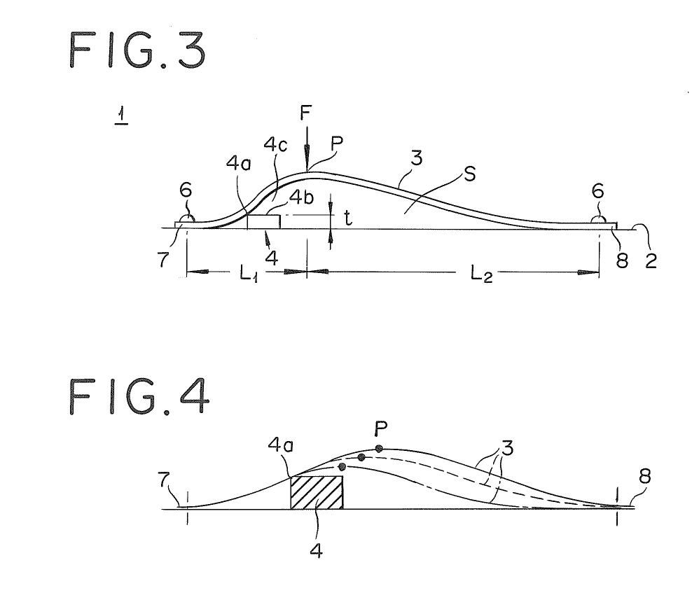

The elastic plate 3 is made of a thin rectangular material (e.g. , a metal plate made of spring steel or stainless steel, plastic plate, etc.), is affixed to the top surface of the base plate 2 at both end portions 7 and 8 with bolts 6 as shown in FIG. 1, and, as a whole, is bent like an arc forming a space S relative to the base plate 2 for allowing itself to deform as shown in FIG. 2. As can be seen there, since the elastic plate 3 is installed on the top surface of the base plate 2 rising upward, it creates a space S between the base plate 2 and itself, so that the elastic plate 3 can elastically develop a downwardly convex shape using the space S when the elastic plate 3 receives a load F (see FIG. 3) from above, thus being able to be used as an elastic energy storage. However, the elastic plate 3 of the present embodiment is formed in such a way that its peak point P (see FIG. 3) of the arc curve is located away from the longitudinal center of the elastic plat 3.

The space member 4 is a block provided on the base plate 2 on the side where a distance L1 from the peak point P to the fixed end potion 7 is smaller than a distance L2 to the other fixed end potion 8, in other words at a position between the fixed end potion 7 of the elastic plate 3 and the peak point P of the arc curve, which is also a location between the elastic plate 3 and the base plate 2. However, the spacer member 4 can be provided on the side of the elastic plate 3 between the fixed end potion 7 of the elastic plate 3 and the peak point P of the arc curve. In addition to having a fulcrum point 4a (see FIG. 3) to support elastic plate 3 in the vicinity of the fixed end 7, the spacer member 4 forms a space 4c for allowing the elastic member 3 to deform between its surface opposite to the base plate (top surface 4b) and the elastic plate 3.

The material of the spacer member 4 is not limited specifically, but rather can be anything so long as it can withstand the load F, for example, a plate with a certain thickness “t” made of metal, wood, plastics, etc.

The peak point P of the elastic plate 3 supported at both end potions as shown in FIG. 3 moves toward the fulcrum point 4a of the space member 4 as shown in FIG. 4 when the load F applied at the peak point P is increased. In FIG. 3, 4, this tendency is shown exaggerated by multiplying the change in the vertical axis direction several times.

Using this movement of the peak point P, one can adjust the system in such a way that the spacer member 4 is located directly below the load point when a load F exceeds a certain amount. Therefore, by installing the space member 4 to a position where it would limit the elastic deformation of the elastic plate 3 to proceed any further once such a condition is reached, the elastic plate 3 can be prevented from making unnecessary elastic deformation when an excessive force F is applied, thus protecting the piezoelectric element 5.

The piezoelectric element 5 consists of a flat piezoelectric ceramic plate 5a, and a water resistant material 9 to cover the piezoelectric ceramic plate 5a, and it is glued on the top surface of the elastic plate 3. However, it can be glued not only on the top surface, but can also be glued only on the bottom surface, or either the top or bottom surface, or on both surfaces.

The piezoelectric element 5 of the present embodiment is glued on a generally flat area of the elastic plate with a gradual slope at a location away from the peak point P of the curved elastic plate 3. In attaching the piezoelectric element 5 to the elastic plate 3 bent in an arc curve, the location was selected noting the presence of a generally flat area with a diminishing curvature away from the peak point. It was confirmed that, by using such a flat area H as the location for attaching the piezoelectric element 5, the flexing of the piezoelectric element 5 during the attaching process remains relatively small, so that only the attaching process becomes easier but also the peeling of the piezoelectric element 5 is minimized. Moreover, such a constitution provides a space for allowing the elastic plate to deform relative to the base plate so that the piezoelectric element can be located in the area where it can be easily deformed to store the elastic energy as it is subjected to a load from above.

The water resistant material 9 covering the piezoelectric ceramic plate 5a is made of an organic material, e.g., rubber, elastomer, etc. When the piezoelectric ceramic plate 5 is covered with such a material, it also forms a mechanically robust structure unlikely to be damaged, increasing the ease of fabrication and its usefulness,

Next, the operational effect of the present embodiment will be described below.

In order to assemble the piezoelectric generator 1 of the present embodiment, the piezoelectric ceramic plate 5a is set on the curved elastic plate 3 and is covered with the water-resistant material 9. The assembly work is completed when this elastic plate 3 is mounted on the base plate 2 and it's both ends area affixed by the bolts 6.

Therefore, this piezoelectric generator 1 comes to have a robust structure as the elastic plate 3 is assembled to the sturdy base plate 2, is easy to assemble, is water resistance, and detects vibrations and pressures with a high sensitivity to perform power generation.

Next, in order to generate electric power, the piezoelectric generator 1 according to the present embodiment is installed on the road surface where there are traffics of people or vehicles. In installing it, the base plate 2 is affixed to an anchoring plate to be installed on the road surface and then it is affixed to the road surface with anchor bolts, etc.

When a load F is applied from above by traveling people and vehicles onto the elastic plate 3 of the installed piezoelectric generator 1, the elastic plate 3 develops a substantial deformation to produce a downward convex shape because there is a space S formed underneath the elastic plate 3, and a compressive strain occurs in the inside of the entire flat piezoelectric ceramic plate 5a over its entirety with the progress of the deformation, generating electric energy. In this case, although the shape of the elastic plate 3 becomes downward convex in the vicinity of the fixed end 8, it does not develop a downward convex deformation unnecessarily due to the influence of the spacer member 4, so that it does not cause any tensile strain in the longitudinal direction at the end of the piezoelectric ceramic plate 5a. Therefore, the strain that develops in the piezoelectric ceramic plate 5a becomes generally a compressive strain, so that no cancellation of charges occurs, thus developing a large electric energy. This electric energy is collected via the lead wires D and stored into a capacity or a secondary battery not shown here.

When the load F is removed, the elastic energy stored in the elastic system including the piezoelectric ceramic plate 5a and the elastic plate 3 is released, and the piezoelectric ceramic plate 5a is agitated again by impact vibrations caused during the elastic energy releasing process, so that the piezoelectric ceramic plate 5a develops a strain over its entirety, thus generating an electric energy as well.

Moreover, in case of the elastic plate 3 bent in an arc shape, the spring constant when a pressure is applied to the peak point P is several tens of times larger than the spring constant of a straight beam affixed on both ends, so that the elastic energy that can be stored as expressed in the aforementioned formula (1) becomes larger, thus causing a larger distortion of the piezoelectric ceramic plate 5a caused by said vibrations, and hence a larger amount of power generation.

Although the elastic plate 3 deforms in the space S and the deformation allowing space 4c when the load F is applied on the peak point P of the elastic plate 3 as well, the peak point P gradually shifts as shown in FIG. 4 in this case, so that the load F is supported by the spacer member 4, and the elastic plate 3 is protected from creating unnecessary deformations.

The electric energy thus obtained can be used for road sign displays and the like by turning light-emitting diodes on and off or can be used as a standby power source for signal processing systems and the like by being stored in a capacitor.

### Example

The piezoelectric element 5 has a silver electrode formed on the top surface of a rectangular piezoelectric ceramic plate 5a (35 mm×18 mm×0.6 mm) and is polarization treated in the thickness direction. As the piezoelectric material, a material with an electromechanical coupling factor k31 of over 30%, a relative dielectric constant e r of 1800, and a mechanical quality coefficient Qm of approximately 1000 is used.

The elastic plate 3 (130 mm×30 mm×1.6 mm) used was a glass epoxy resin FR-4 formed into a gradually curved shape. The spacer member 4 (30 mm×15 mm×2 mm) used was an iron block.

If an electrically conductive material such as a metal is used as the elastic plate 3, it is possible to get conductivity by connecting with one of the electrodes of the piezoelectric element 5 and to take out the lead wire D of one of the terminals from the top surface of the base plate 2, but the two lead wires D are connected as shown in FIG. 1 using a glass epoxy elastic plate 3 the surface of which is copper plated to be used for circuits.

In assembling the piezoelectric generator 1, both end portions of the elastic plate 3 are affixed using the bolts 6 and the mounting holes formed on two locations of a base plate 2 (100 mm×35 mm×3 mm) made of aluminum. The spacer member 4 is provided close to the mounting hole on one side. The location where the fulcrum point 4a located at the corner of the spacer member 4 contacts with the elastic plate 3 was adjusted to be 2 mm from the edge. When the base plate 2 is positioned horizontal, the peak point P of the elastic plate 3 is approximately 10 mm away from the base plate 2 and closer to the spacer member 4, while its height from the top surface of the base plate 2 is 5 mm. The piezoelectric element 5 is glued onto an approximately flat area with only a small bending located more than 10 mm away from the peak point P.

The spring constant K at the peak point P calculated from the load F applied on the peak point P and the displacement was 333,000 (N/m). On the other hand, the spring constant K calculated for the base plate 2 from the displacement by assuming a force being applied to a simple beam fixed at both ends without the spacer member 4 and without any bending was 56,800 (N/m). Therefore, it is confirmed that the spring constant increased 5.9 times with the constitution of the present embodiment. This is an adequate spring characteristic for the load F expected to be applied by human steps to provide sufficient displacements. It was confirmed output voltage of 100 to 200 V was generated by human load.

As shown in FIG. 2, the entire surface of the piezoelectric ceramic plate 5a glued onto the elastic plate 3 was coated with the epoxy based adhesive (Bond Quick 30 by Konishi) to a thickness of approximately 0.5 mm and hardened at room temperature. It was confirmed that the coating provides sufficient humidity resistance, insulation protection between the electrodes, and mechanical protection of the piezoelectric ceramic plate 5a. Although there is a possibility that the bending elasticity of the piezoelectric ceramic plate 5a may increase due to the coating by the epoxy adhesive, it was found that it is still sufficiently smaller than the bending elasticity of the constituent materials of the elastic plate 3 so that no material effect was observed on the deformation under the load F, vibrations during the process, and power generating performances.

The spring constant K at the peak point P calculated from the load F and the displacement was 125,800 (N/m), and the deviation from the value prior to the coating was that of a negligible level.

The coating material for the piezoelectric ceramic plate 5a can be arbitrarily selected from phenolic resin, polyamide resin, etc. The coating method can be selected from molding with urethane rubber, hot melt molding, etc. The entire unit can also be coated if a proper coating material is selected in order to further improve humidity resistance, insulation protection between electrodes, and mechanical protection.

The invention is not limited to the embodiment described above, but also can be changed in various ways within the scope of the claims. For example, although the piezoelectric element 5 is rectangular shaped in the embodiment described above, the invention is not limited to it but can have a modified aspect ratio, or can have a multilayer lamination.

Claims:

1. A piezoelectric generator for causing strains in a piezoelectric element by external forces or vibrations to generate electrical energy comprising:
a flat base plate;
an elastic plate, which is bent in an arc shape and is attached to said base plate at both ends thereof so that a space is created to allow the elastic plate to deform between it and the particular base plate; and
a spacer member having a fulcrum, which is located between one of the fixed ends of the particular elastic plate and the peak point of said arc-like curve for supporting said elastic plate in the vicinity of said one end of thereof, the spacer member being provided to form a space between its side opposite to the base plate and said elastic plate for allowing the elastic plate to deform; wherein
said piezoelectric element is glued to at least one of the front and back surfaces of said elastic plate.

2. The piezoelectric generator according to claim 1 wherein said elastic plate is of a rectangular shape and is formed in such a way that said peak point is located away from the longitudinal center.

3. The piezoelectric generator according to claim 1 wherein said piezoelectric element is glued on a generally flat area of said elastic plate with a gradual slope at a location away from the peak point P of said curved elastic plate.

4. The piezoelectric generator according to claim 1 wherein said spacer member is provided between said elastic plate and said base plate at a location where the distance from said peak point to said one of the fixed ends is smaller.

5. The piezoelectric generator according to claim 1 wherein said piezoelectric element contains a flat piezoelectric ceramic plate, and said piezoelectric ceramic plate is coated with a water-resistant material.

6. The piezoelectric generator according to claim 5 wherein said water-resistant material contains an organic material such as rubber, elastomer, etc.
